(19) United States
(12) Patent Application Publication
(10) Pub. No.: US 2024/0209295 A1
(43) Pub. Date: Jun. 27, 2024

(54) UNIT DOSE PRODUCT COMPRISING A LIQUID COMPOSITION WITH ENCAPSULATED FRAGRANCE AND A POWDER COMPOSITION WITH PIGMENT

(71) Applicant: Henkel AG & Co. KGaA, Duesseldorf (DE)

(72) Inventors: Jessica Eileen McKeon, Stamford, CT (US); Daniel Joseph Skelly, Trumbull, CT (US); Wei Sun, Livingston, NJ (US); Daniel Thomas Piorkowski, Fairfield, CT (US); Mariusz Hildebranski, Mississauga (CA)

(73) Assignee: Henkel AG & Co. KGaA, Duesseldorf (DE)

(21) Appl. No.: 18/499,329

(22) Filed: Nov. 1, 2023

Related U.S. Application Data
(60) Provisional application No. 63/476,703, filed on Dec. 22, 2022.

(51) Int. Cl. C11D 17/04; C11D 3/00; C11D 3/30; C11D 3/37; C11D 3/40; C11D 3/43; C11D 3/50

(52) U.S. Cl. CPC C11D 17/045; C11D 3/0005; C11D 3/0047; C11D 3/30; C11D 3/3761; C11D 3/40; C11D 3/43; C11D 3/505

(57) ABSTRACT

The present disclosure provides a unit dose product comprising a water-soluble film material comprising a first compartment that is adjacent to a second compartment. The first compartment encloses a liquid composition comprising an encapsulated fragrance and a non-aqueous solvent. The liquid composition can further comprise at least one additive selected from a rheology modifier, a pH-adjusting agent, water, and a bitterant. The second compartment encloses a powder composition comprising a salt, a fragrance oil, a pigment, such as a metal-containing pigment, and a flow aid. Also provided is a method of preparing the powder composition enclosed in the second compartment in the unit dose product comprising adding the pigment to the salt to provide a pigment-salt combination; followed by adding the flow aid to the pigment-salt combination.

### CROSS-REFERENCE TO A RELATED APPLICATION

This patent application claims the benefit of U.S. Provisional Patent Application No. 63/476,703, filed Dec. 22, 2022, the disclosure of which is incorporated by reference for all purposes.

### BACKGROUND

Unit dose products formed from a water-soluble film and containing a liquid composition comprising water exhibit migration. Water can move between materials and will migrate from high water active materials to low water active materials. Other solvents, including polyethylene glycol (PEG), can also move between materials and tend to disperse from concentrated regions to less concentrated regions. That is, PEG migrates from the liquid chamber where it is plentiful to the powder chamber where it is scarce until it reaches an equilibrium. Liquid compositions containing encapsulated fragrance typically include water to stabilize the encapsulations. A relatively inert and inexpensive base of powder formulations is salt, which has a very low water activity. Therefore, in a unit dose product containing both powder and water-containing liquid chambers, solvents tend to migrate from the liquid chamber to the powder chamber.

The aesthetics of a unit dose product can be improved by adding colorant to the powder composition. However, the migration of water from the liquid chamber to the powder chamber can disperse the colorant across the powder and create unsightly rings of uncoloured powder ringed in darker powder throughout the powder chamber.

Thus, there remains a need for a unit dose product with color stability despite solvent migration.

### BRIEF SUMMARY

The present disclosure relates to a unit dose product comprising
a water-soluble film material comprising a first compartment and a second compartment; wherein the first compartment is adjacent to the second compartment and the first and second compartments are separated by at least one layer of the film;
the first compartment enclosing a liquid composition comprising an encapsulated fragrance and a non-aqueous solvent; and
the second compartment enclosing a powder composition comprising a salt, a fragrance oil, a pigment, and a flow aid.

In some aspects, the liquid composition further comprises at least one additive selected from a rheology modifier, a pH-adjusting agent, water, and a bitterant.

In some aspects, the pigment comprises at least one metal selected from the group consisting of aluminum, barium, cadmium, chromium, cobalt, copper, iron oxide, manganese, mercury, titanium, zinc, and any combination thereof.

In some aspects, the powder composition comprises about 0.001 wt % to about 3 wt % of pigment. In some aspects, the powder composition does not contain a dye.

In some aspects, the encapsulated fragrance comprises a polymer shell encapsulating at least one fragrance oil. In some aspects, the polymer shell of the encapsulated fragrance comprises a polymer selected from the group consisting of a melamine formaldehyde, a polyamide, a polystyrene, a polyisoprene, a polycarbonate, a polyester, a polyurea, a polyurethane, a polyureaurethane, a polyolefin, a polyacrylate, a vinyl polymer, a polysaccharide, a gum, an epoxy resin, gelatin, shellac, silicone, silk, wool, gelatine, a cellulose, a protein, and any combination thereof.

In some aspects, the non-aqueous solvent comprises an alcohol, a glycol, a polyethylene glycol, or any combination thereof. In some aspects, the non-aqueous solvent comprises polyethylene glycol, glycerin, and propylene glycol.

In some aspects, the liquid composition comprises water in an amount of 1 wt % to 20 wt % relative to the components in the liquid composition. In some aspects, the liquid composition comprises about 10 wt % to about 20 wt % water.

In some aspects, the liquid composition comprises a rheology modifier that is an acrylic polymer, an acrylic copolymer, an Alkali Soluble Emulsion (ASE) polymer, or a Hydrophobically Modified Alkali Soluble Emulsion (HASE) polymer. In some aspects, the rheology modifier is a copolymer comprising acrylic acid monomer units and alkyl acrylate monomer units.

In some aspects, the liquid composition comprises a pH adjusting agent that is selected from the group consisting of triethanolamine, monoethanolamine, tromethamine, sodium carbonate, sodium s bicarbonate, trisodium phosphate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), tetrasodium glutamate diacetate (GLDA), hydrochloric acid, nitric acid, nitrous acid, sulfuric acid, sulfurous acid, phosphoric acid, boric acid, hydrobromic acid, hydroiodic acid, perchloric acid, formic acid, acetic acid, propionic acid, butanoic acid, quinic acid, shikimic acid, lactic acid, sorbic acid, caproic acid, caprylic acid, capric acid, lauric acid, and stearic acid, citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, oxalic acid, and any combination thereof.

In some aspects, the salt comprises a chloride, a bromide, an iodide, a fluoride, a nitrate, a nitrite, a sulfate, a sulfite, a sulfide, a phosphate, a phosphide, a carbonate, a bicarbonate, or any combination thereof.

In some aspects, the flow aid comprises silica, calcium oxide, a silicate, an aluminate, a carbonate, a bicarbonate, a phosphate, a stearate, clay, flour, fly ash, starch, zeolite, or a combination thereof.

In some aspects, the second compartment surrounds the first compartment.

In some aspects, the water-soluble film material comprises polyvinyl alcohol.

In some aspects, the present disclosure is directed to a method of preparing the powder composition enclosed in the second compartment in the unit dose product comprising adding the pigment to the salt to provide a pigment-salt combination; followed by adding the flow aid to the pigment-salt combination. In some aspects of this method, the powder composition comprises about 0.001 wt % to about 3 wt % of pigment.

### BRIEF DESCRIPTION OF THE FIGURES

The patent or application file contains at least one drawing executed in color. Copies of this patent or patent application publication with color drawing(s) will be provided by the Office upon request and payment of the necessary fec.

FIG. 1 is a series of color photographs of unit dose products containing a liquid composition and a powder composition comprising dye. For each unit dose product, the left photograph is at the time of preparation (time 0), whereas the right photograph is after the unit dose product was aged for 4 weeks at 25° C.

FIG. 2 is a series of color photographs of unit dose products containing a liquid composition and a powder composition comprising pigment. For each unit dose product, the left photograph is at the time of preparation (time 0), whereas the right photograph is after the unit dose product was aged for 4 weeks at 25° C.

FIG. 3 is a color photograph of samples of polyethylene glycol (PEG) 400 (control), PEG 400+pigment extraction (inventive), and PEG 400+dye extraction (comparative) demonstrating a change in color values for a non-aqueous solvent that was soaked with pigmented powder versus dyed powder.

### DETAILED DESCRIPTION

Provided herein is a unit dose product comprising a water-soluble film material comprising a first compartment and a second compartment; wherein the first compartment is adjacent to the second compartment and the first and second compartments are separated by at least one layer of the film; the first compartment enclosing a liquid composition comprising an encapsulated fragrance and a non-aqueous solvent; and the second compartment enclosing a powder composition comprising a salt, a fragrance oil, a pigment, and a flow aid.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number+10%. For example, “about 10” means 9 to 11.

The phrase “substantially free of” means that a composition contains little or no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one additive” means that 1, 2, 3, 4, or 5 or more additives are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

The term “by weight of the composition” as used in the present application refers to a composition of a final product derived from a process, unless otherwise defined.

The terms “process” and “method” as used in the present application can be used interchangeably.

The terms “preventing” or “prevents” as used in the present application refer to a pigment stain not forming when a textile is contacted with a unit dose product described herein. In some aspects, the preventing can be to any suitable degree, but typically a dry textile that has been in contact with a unit dose product described herein has a degree of staining that can be visually labeled as “clean” or “small amount of acceptable staining.” Unacceptable degrees of staining include those that can be visually labeled as “noticeable staining.”

### Unit Dose Product

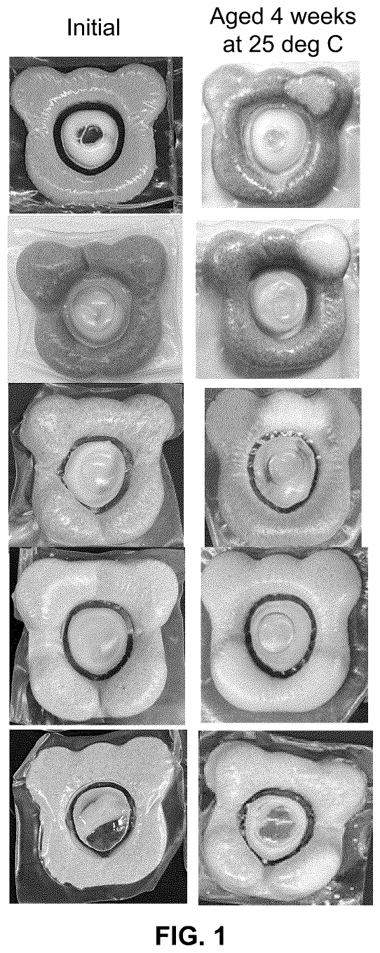

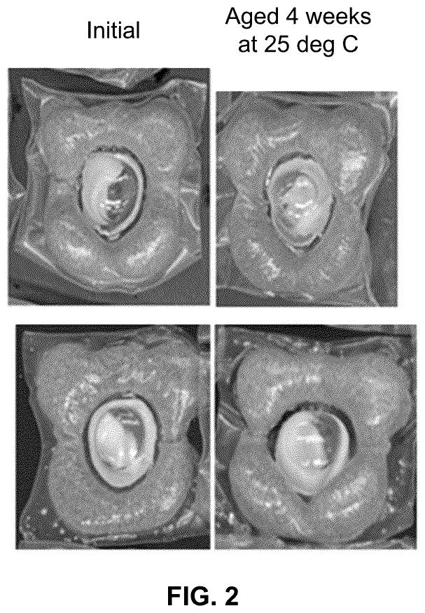

The present disclosure is predicated on the discovery that solvent migration causing unsightly discoloration of colored powders in unit dose products can be minimized through the use of pigments (FIGS. 1 and 2). Pigments are typically less appropriate for in-wash laundry products than dyes because pigments are not water soluble and therefore pose increased staining risk compared to dyes. Pigments can also offset the color of fabrics, such as the yellowing of white fabrics. Moreover, pigments can contain high levels of heavy metals, which can react with other laundry additives or stain fabrics in the wash. Extensive testing demonstrated that at certain levels and with proper handling, inclusion of pigment prevents discoloration, in particular white spot formation, in colorful unit dose powders without staining fabric.

In some aspects, the present disclosure is directed to a unit dose product comprising a water-soluble film material comprising a first compartment and a second compartment; wherein the first compartment is adjacent to the second compartment and the first and second compartments are separated by at least one layer of the film; the first compartment enclosing a liquid composition comprising an encapsulated fragrance and a non-aqueous solvent; and the second compartment enclosing a powder composition comprising a salt, a fragrance oil, a pigment, and a flow aid. The unit dose product is useful as an in wash laundry scent booster when washing textiles. The unit dose product was found to have a long, stable shelf life from an aesthetic perspective and does not deposit pigment on textiles when used in laundry care.

The first compartment encloses a liquid composition comprising an encapsulated fragrance and a non-aqueous solvent.

Encapsulated fragrance typically comprises a fragrance oil enclosed within a polymer shell that imparts long-lasting freshness and odor control to washed laundry. Within a wash load, the fragrance oil disperses from the shell, typically through diffusion or rupturing or dissolution of the shell, thereby allowing the fragrance oil to infuse into the textiles being washed. Rupturing the shell can be mechanical, based on temperature, or both.

The fragrance can be any suitable fragrance oil that is generally regarded as safe (GRAS) at the levels used in the liquid composition.

In some aspects, the shell is a hollow capsule formed from one or more polymers and that acts as a coating for the fragrance oil. In some aspects, the shell is not hollow but allows for the fragrance oil to be dispersed within the polymer matrix. The polymer can be natural or synthetic. In some aspects, the polymer is a water soluble polymer. In some aspects, the one or more polymers can be, for example, a melamine formaldehyde, a polyamide, a polystyrene, a polyisoprene, a polycarbonate, a polyester, a polyurea, a polyurethane, a polyureaurethane, a polyolefin, a polyacrylate, a vinyl polymer, a polysaccharide (e.g., cyclodextrin, chitosan, carrageenan), a gum (e.g., guar gum (acacia), gum Arabic, gellan gum, gum tragacanth), an epoxy resin, gelatin, shellac, silicone, silk, wool, gelatine, a cellulose (e.g., carboxymethyl cellulose, hydroxymethylcellulose, hydroxyethylcellulose, hydroxypropylcellulose, hydroxypropyl methylcellulose, microcrystalline cellulose), a protein (e.g., zein), or any combination thereof. Combinations of polymers includes, for example, polyethylene glycol/polycaprolactone, polyethylene glycol/polyvinyl acetate, polyurethane/β-cyclodextrin, silk fibroin/β-cyclodextrin, cellulose derivatives/polyvinyl alcohol, gelatin/acacia, and polyvinyl alcohol/gum Arabic/β-cyclodextrin. In some aspects, the polymer shell comprises a melamine formaldehyde. The shell can be any suitable size and typically is on a micron scale (e.g., about 3 to about 25 μm).

Examples of encapsulated fragrances are described in, for example, U.S. Pat. Nos. 6,024,943, 6,056,949, 6,194,375, 6,458,754, 8,426,353, and 10,047,324, and U.S. Patent Application Publication 2011/0224127, each of which is incorporated by reference in its entirety.

The encapsulated fragrance can be used in solid, dry form (i.e., without solvent) or as a slurry (i.e., dispersed in one or more solvents). In some aspects, the encapsulated fragrance is a slurry comprising one or more solvents. Suitable solvents include, for example, water, a glycol (e.g., glycerin, propylene glycol, dipropylene glycol), an alcohol (e.g., ethanol, phenoxyethanol), an ethoxylated fatty alcohol (e.g., ethoxylyated C₁₂₋₁₅ alcohol), or any combination thereof. In some aspects, the encapsulated fragrance contains about 40-80% water. In some aspects, the encapsulated fragrance includes one or more solid carriers, such as a zeolite (e.g., faujasite, mordonite), silica, or gum tragacanth. When one or more solvents are used, the solids content of the slurry can vary. In some aspects, the solids content is about 50% in the slurry.

In some aspects, the liquid composition comprises from about 10 wt % to about 35 wt % of encapsulated fragrance relative to the total weight of the liquid composition. For example, the total surfactant content can be present in an amount from about 10 wt % to about 32 wt %, about 10 wt % to about 30 wt %, about 10 wt % to about 28 wt %, about 10 wt % to about 25 wt %, about 10 wt % to about 32 wt %, about 10 wt % to about 30 wt %, about 10 wt % to about 28 wt %, about 10 wt % to about 25 wt %, about 12 wt % to about 35 wt %, about 12 wt % to about 32 wt %, about 12 wt % to about 30 wt %, about 12 wt % to about 28 wt %, about 12 wt % to about 25 wt %, about 15 wt % to about 35 wt %, about 15 wt % to about 32 wt %, about 15 wt % to about 30 wt %, about 15 wt % to about 28 wt %, about 15 wt % to about 25 wt %, about 18 wt % to about 35 wt %, about 18 wt % to about 32 wt %, about 18 wt % to about 30 wt %, about 18 wt % to about 28 wt %, about 18 wt % to about 25 wt %, about 20 wt % to about 35 wt %, about 20 wt % to about 32 wt %, about 20 wt % to about 30 wt %, about 20 wt % to about 28 wt %, about 20 wt % to about 25 wt %, about 22 wt % to about 35 wt %, about 22 wt % to about 32 wt %, about 22 wt % to about 30 wt %, about 22 wt % to about 28 wt %, about 22 wt % to about 25 wt %, about 25 wt % to about 35 wt %, about 25 wt % to about 32 wt %, about 25 wt % to about 30 wt %, about 25 wt % to about 28 wt %, about 35 wt %, about 32 wt %, about 30 wt %, about 28 wt %, about 25 wt %, about 22 wt %, about 20 wt %, about 18 wt %, about 15 wt %, about 12 wt %, or about 10 wt % of the total weight of the liquid composition. In some aspects, the liquid composition comprises from about 15 wt % to about 35 wt % of encapsulated fragrance relative to the total weight of the liquid composition.

The non-aqueous solvent is any suitable solvent that has minimal impact on the encapsulated fragrance or film that forms the unit dose product. In some aspects, the non-aqueous solvent comprises an alcohol (e.g., a C₁₋₄ alcohol), a glycol, a polyethylene glycol, or any combination thereof. In some aspects, the glycol is selected from ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, glycerin, and any combination thereof. In some aspects, the glycol is propylene glycol, glycerin, or a combination of both.

In some aspects, the at least one non-aqueous solvent comprises polyethylene glycol (PEG), which can have the structure:

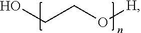

wherein n is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/mol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, about 600 g/mol, about 800 g/mol, or about 1000 g/mol). In some aspects, the non-aqueous solvent comprises polyethylene glycol with a molecular weight of about 200 to about 1000 g/mol or about 400 g/mol.

In some aspects, the liquid composition comprises from about 55 wt % to about 80 wt % of at least one non-aqueous solvent relative to the total weight of the liquid composition. For example, the total non-aqueous solvent content can be present in an amount from about 55 wt % to about 78 wt %, about 60 wt % to about 80 wt %, about 60 wt % to about 75 wt %, about 60 wt % to about 72 wt %, about 60 wt % to about 70 wt, about 65 wt % to about 80 wt %, about 65 wt % to about 75 wt %, about 65 wt % to about 72 wt %, about 65 wt % to about 70 wt, about 70 wt % to about 80 wt %, about 70 wt % to about 75 wt %, about 70 wt % to about 72 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, or about 80 wt % of the total weight of the liquid composition.

In some aspects, the non-aqueous solvent comprises polyethylene glycol, glycerin, and propylene glycol. In some aspects, the non-aqueous solvent comprises about 30 wt % to about 40 wt % polyethylene glycol, about 20 wt % to about 30 wt % glycerin, and about 6 wt % to about 18 wt % propylene glycol. The polyethylene glycol (PEG), glycerin, and propylene glycol (PG) can be used in any suitable ratio in the liquid composition. In some aspects, the weight ratio of PEG:Glycerin:PG will be about 3:2:1±10%.

In some aspects, the liquid composition comprises at least one (e.g., 1, 2, 3, 4, 5, or 6, etc.) additive. In some aspects, the additive is any suitable component that does not increase solvent migration or discoloration of the powder composition. In some aspects, the additive can be a rheology modifier, a pH-adjusting agent, water, a bitterant, or any combination thereof.

In some aspects, the liquid composition comprises from about 0.5 wt % to about 25 wt % of a total amount of additives relative to the total weight of the liquid composition. For example, the total amount of additives can be from about 0.5 wt % to about 20 wt %, about 0.5 wt % to about 15 wt %, about 0.5 wt % to about 12 wt %, about 0.5 wt % to about 10 wt %, about 0.5 wt % to about 8 wt %, about 0.5 wt % to about 5 wt %, about 0.5 wt % to about 3 wt %, about 1 wt % to about 25 wt %, about 1 wt % to about 20 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 25 wt %, about 1.5 wt % to about 20 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 25 wt %, about 2 wt % to about 20 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 0.5 wt %, about 0.8 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 12 wt %, about 15 wt %, about 18 wt %, about 20 wt %, about 22 wt %, or about 25 wt % of the total weight of the composition.

In some aspects, the liquid composition comprises a rheology modifier as an additive. Typically, the rheology modifier is a polymer that swells in the presence of water and other solvents. Some rheology modifiers contain acid groups and require neutralization to become activated. Once activated, the rheology modifier increases the viscosity of the liquid composition. Suitable examples of a rheology modifier include, for example, an acrylic polymer or copolymer (e.g., an acid-containing, cross-linked acrylic emulsion copolymer, a cross-linked polyacrylic acid, an acrylic acid-alkyl acrylate copolymer, a hydrophobically-modified polyacrylate crosspolymer, quaternized polyacrylic acid), an Alkali Soluble Emulsion (ASE) polymer, a Hydrophobically Modified Alkali Soluble Emulsion (HASE) polymer, or any combination thereof. An ASE or HASE polymer typically is a carboxyl-containing copolymer prepared by the addition polymerization of ethylenically unsaturated monomers. ASE polymers are either alkali-swellable or alkali-soluble emulsions. A HASE polymer is an ASE polymer that has been modified with hydrophobic groups.

In some aspects, the rheology modifier is an acrylic-based polymer, such as a carbomer. In some aspects, the rheology modifier is a copolymer comprising acrylic acid monomer units and alkyl acrylate monomer units.

In some aspects, the rheology modifier is a HASE polymer. In some aspects, the HASE polymer has the following structure:

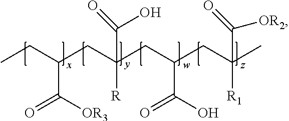

wherein R, R₁, and R₃ are independently selected from H and C₁₋₁₀ alkyl groups, R₂ is an optionally alkoxylated C₁₋₂₀ alkyl group, and w, x, y and z are integers.

In some aspects, R and R₁ are independently selected from C₁₋₁₀ alkyl groups, R₂ is an ethoxylated C₁₋₂₀ alkyl group, and R₃ is H or a C₁₋₆ alkyl. In some aspects, R and R₁ are methyl groups, R₂ is an ethoxylated C₈₋₂₀ alkyl group, and R₃ is an ethyl group. In some aspects, the repeating units comprising R, R₁, R₂, and R₃ can be in any suitable order, or even randomly distributed through the polymer chain.

In some aspects, the HASE polymer can have a molecular weight of about 50,000 to about 500,000 g/mol, about 80,000 to about 400,000 g/mol, about 100,000 to about 300,000 g/mol, about 50,000 to about 450,000 g/mol, about 50,000 to about 400,000 g/mol, about 50,000 to about 350,000 g/mol, about 50,000 to about 300,000 g/mol, about 50,000 to about 250,000 g/mol, about 50,000 to about 200,000 g/mol, about 50,000 to about 150,000 g/mol, about 50,000 to about 100,000 g/mol, about 100,000 to about 500,000 g/mol, about 150,000 to about 500,000 g/mol, about 200,000 to about 500,000 g/mol, about 250,000 to about 500,000 g/mol, about 300,000 to about 500,000 g/mol, about 350,000 to about 500,000 g/mol, about 400,000 to about 500,000 g/mol, or about 450,000 to about 500,000 g/mol. In some aspects, the HASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In some aspects, the ratio of x:y is between 1:20 to 20:1, between 1:10 to 10:1, or between 1:5 to 5:1. In some aspects, the ratio of x:w is between 1:20 to 20:1, between 1:10 to 10:1, or between 1:5 to 5:1. In some aspects, the ratio of x:z can be between 1:1 to 500:1, between 2:1 to 250:1, or between 25:1 to 75:1.

Methods of making such HASE polymer are described in U.S. Pat. Nos. 4,514,552, 5,192,592, and 7,217,443 and British Patent No. 870,994, each of which is incorporated herein by reference.

In some aspects, the rheology modifier is an ASE polymer. In some aspects, the ASE polymer has the following structure:

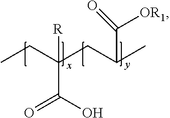

wherein R is H or C₁₋₂₀ alkyl, R₁ is C₁₋₂₀ alkyl, and x and y are integers.

In some aspects, the ratio of x:y is about 1:20 to about 20:1, about 1:10 to 10:1, or about 1:5 to 5:1. In some aspects, the ratio of x:w is about 1:20 to about 20:1, about 1:10 to about 10:1, or about 1:5 to about 5:1. In some aspects, the ratio of x:z is between 1:1 to about 500:1, about 2:1 to about 250:1, or about 25:1 to about 75:1.

In some aspects, the ASE polymer has a molecular weight of about 50,000 to about 500,000 g/mol, about 80,000 to about 400,000 g/mol, about 100,000 to about 300,000 g/mol, about 50,000 to about 450,000 g/mol, about 50,000 to about 400,000 g/mol, about 50,000 to about 350,000 g/mol, about 50,000 to about 300,000 g/mol, about 50,000 to about 250,000 g/mol, about 50,000 to about 200,000 g/mol, about 50,000 to about 150,000 g/mol, about 50,000 to about 100,000 g/mol, about 100,000 to about 500,000 g/mol, about 150,000 to about 500,000 g/mol, about 200,000 to about 500,000 g/mol, about 250,000 to about 500,000 g/mol, about 300,000 to about 500,000 g/mol, about 350,000 to about 500,000 g/mol, about 400,000 to about 500,000 g/mol, or about 450,000 to about 500,000 g/mol. In some aspects, the ASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, or about 500,000 g/mol.

In some aspects, the liquid composition comprises a total from about 0.1 wt % to about 5 wt % of a rheology modifier relative to the total weight of the liquid composition. For example, the total rheology modifier content can be from about 0.1 wt % to about 4 wt %, about 0.1 wt % to about 3 wt %, about 0.1 wt % to about 2 wt %, about 0.1 wt % to about 1 wt %, about 0.5 wt % to about 5 wt %, 0.5 wt % to about 4 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 1.5 wt % to about 2 wt %, about 2 wt % to about 5 wt %, about 2 wt % to about 4 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the composition.

In some aspects, the liquid composition comprises a pH-adjusting agent as an additive. The pH-adjusting agent can be an acid, a base or both. In some aspects, the liquid composition comprises a base as a pH-adjusting agent. In some aspects, a base is present to neutralize a rheology modifier.

The base can be any suitable compound with a pKb of about 1 to about 13. In some aspects, the base can be a Group I hydroxide, a Group II hydroxide, a Group I carbonate, a Group II carbonate, monoethanolamine, diethanolamine, triethanolamine, methyl diethanolamine, sodium tetraborate, trisodium phosphate, or any combination thereof. In other aspects, the base is a Group I hydroxide, a Group II hydroxide, sodium tetraborate, trisodium phosphate, sodium carbonate, or any combination thereof. In some aspects, the base can be a Group I hydroxide, such as sodium hydroxide, potassium hydroxide, or a combination of both.

The acid can be any suitable compound with a pKa of less than about 10. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or a combination thereof.

An organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid.

In some aspects, the liquid composition comprises a pH adjusting agent that is selected from the group consisting of triethanolamine (TEA), monoethanolamine (MEA), tromethamine, sodium carbonate, sodium bicarbonate, trisodium phosphate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), tetrasodium glutamate diacetate (GLDA), hydrochloric acid, nitric acid, nitrous acid, sulfuric acid, sulfurous acid, phosphoric acid, boric acid, hydrobromic acid, hydroiodic acid, perchloric acid, formic acid, acetic acid, propionic acid, butanoic acid, quinic acid, shikimic acid, lactic acid, sorbic acid, caproic acid, caprylic acid, capric acid, lauric acid, and stearic acid, citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, oxalic acid, and any combination thereof. In some aspects, the liquid composition comprises triethanolamine (TEA) as a pH-adjusting agent.

In some aspects, the liquid composition comprises from about 0.1 wt % to about 5 wt % of a pH adjusting agent (e.g., a base) relative to the total weight of the liquid composition. For example, the total pH adjusting agent content can be from about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 0.8 wt % to about 5 wt %, about 0.8 wt % to about 3 wt %, about 0.8 wt % to about 2 wt %, about 0.8 wt % to about 1 wt %, about 1 wt % to about 5 wt %, about 1 wt % to about 4 wt %, about 1 wt % to about 3 wt %, about 1 wt % to about 2 wt %, about 1.5 wt % to about 5 wt %, about 1.5 wt % to about 4 wt %, about 1.5 wt % to about 3 wt %, about 1.5 wt % to about 2 wt %, about 2 wt % to about 5 wt %, about 2 wt % to about 4 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the liquid composition. In some aspects, the liquid composition comprises from about 0.4 wt % to about 1.5 wt % of a pH adjusting agent

In some aspects, the liquid composition comprises water as an additive. In some aspects, the liquid composition comprises from about 1 wt % to about 20 wt % of water relative to the total weight of the liquid composition. For example, the water content can be present in an amount from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 8 wt %, about 10 wt % to about 20 wt %, about 10 wt % to about 18 wt %, about 10 wt % to about 15 wt %, about 10 wt % to about 12 wt %, about 12 wt % to about 20 wt %, about 12 wt % to about 18 wt %, about 12 wt % to about 15 wt %, about 15 wt % to about 20 wt %, about 15 wt % to about 18 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt %, about 5 wt %, about 4 wt %, about 3 wt %, about 2 wt %, or about 1 wt % of the total weight of the liquid composition. In some aspects, the liquid composition comprises about 10 wt % to about 20 wt % or about 12 wt % to about 18 wt %.

In some aspects, the liquid composition does not include water. In some aspects, the liquid composition does not comprise added water but includes water as part of another component, such as water from the encapsulated fragrance.

In some aspects, the liquid composition comprises a bitterant as an additive. A bitterant (e.g., a bittering agent) can be any suitable compound that imparts a bitter taste to the composition. The bitterant can be added to avoid accidental poisoning. Examples of the bitterant include, e.g., denatonium benzoate, sucrose octaacetate, quercetin, brucine, quassin, and combinations thereof. In an aspect, the bitterant is denatonium benzoate.

In some aspects, the liquid composition can comprise from about 0.001 wt % to about 2 wt % of a bitterant relative to the total weight of the liquid composition. For example, the bitterant can be present in an amount about 0.001 wt % to about 1.8 wt %, about 0.001 wt % to about 1.5 wt %, about 0.001 wt % to about 1.2 wt %, about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 2 wt %, about 0.005 wt % to about 1.8 wt %, about 0.005 wt % to about 1.5 wt %, about 0.005 wt % to about 1.2 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 2 wt %, about 0.01 wt % to about 1.8 wt %, about 0.01 wt % to about 1.5 wt %, about 0.01 wt % to about 1.2 wt %, about 0.01 wt % to about 1 wt %, about 0.01 wt % to about 0.9 wt %, about 0.01 wt % to about 0.8 wt %, about 0.01 wt % to about 0.5 wt %, about 0.05 wt % to about 2 wt %, about 0.05 wt % to about 1.8 wt %, about 0.05 wt % to about 1.5 wt %, about 0.05 wt % to about 1.2 wt %, about 0.05 wt % to about 1 wt %, about 0.05 wt % to about 0.9 wt %, about 0.05 wt % to about 0.8 wt %, about 0.05 wt % to about 0.5 wt %, about 0.05 wt % to about 0.1 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.6 wt %, about 0.1 wt % to about 0.5 wt %, about 0.1 wt % to about 0.2 wt %, about 0.2 wt % to about 2 wt %, about 0.2 wt % to about 1.8 wt %, about 0.2 wt % to about 1.5 wt %, about 0.2 wt % to about 1.2 wt %, about 0.2 wt % to about 1 wt %, about 0.2 wt % to about 0.8 wt %, about 0.2 wt % to about 0.6 wt %, about 0.2 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2 wt % of the total weight of the liquid composition. In some aspects, the liquid composition can comprise from about 0 wt % to about 0.2 wt % of a bitterant relative to the total weight of the liquid composition.

In some aspects, the liquid composition has a pH of about 5 to about 9 (e.g., about 5 to about 8.5, about 5 to about 8, about 5 to about 7.5, about 5 to about 7, about 5.5 to about 8.5, about 5.5 to about 8, about 5.5 to about 7.5, about 5.5 to about 7, about 6 to about 9, about 6 to about 8.5, about 6 to about 8, about 6 to about 7.5, about 6 to about 7, about 6.5 to about 9, about 6.5 to about 8.5, about 6.5 to about 8, about 6.5 to about 7.5, about 6.5 to about 7, about 7 to about 9, about 7 to about 8.5, about 7 to about 8, about 7.5 to about 9, about 7.5 to about 8.5, or about 7.5 to about 8). In some aspects, the liquid composition has a pH of about 5, about 5.1, about 5.2, about 5.3, about 5.4, about 5.5, about 5.6, about 5.7, about 5.8, about 5.9, about 6, about 6.1, about 6.2, about 6.3, about 6.4, about 6.5, about 6.6, about 6.7, about 68, about 6.9, about 7, about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, or about 9.

The second compartment is adjacent to the first compartment and encloses a powder composition. The powder composition comprises a salt, a fragrance oil, a pigment, and a flow aid.

The pigment is any suitable colorant that is generally regarded as safe (GRAS). Any desired color, such as red, blue, yellow, purple, pink, or green, can be used. The pigment can be organic or inorganic but typically is inorganic. Unlike a dye, a pigment is not water soluble. In some aspects, the pigment will contain at least one metal, i.e., a metallic pigment. In some aspects, the pigment comprises at least one metal selected from the group consisting of aluminum, barium, cadmium, chromium, cobalt, copper, iron oxide, manganese, mercury, titanium, zinc, and any combination thereof. In some aspects, the pigment is plant-based. Suitable examples of pigment include, for example, a carotenoid, a phthalocyanine, a chlorophyll, an anthocyanin, a betalain, vermilion, ultramarine blue, ochre, Prussian blue, sienna, umber, carmine, or any combination thereof.

In some aspects, the powder composition does not contain a dye, such as a water soluble dye.

In some aspects, the powder composition comprises from about 0.001 wt % to about 3 wt % of a pigment relative to the total weight of the powder composition. For example, the pigment can be present in an amount from about 0.001 wt % to about 2.8 wt %, about 0.001 wt % to about 2.5 wt %, about 0.001 wt % to about 2.2 wt %, about 0.001 wt % to about 2 wt %, about 0.001 wt % to about 1.8 wt %, about 0.001 wt % to about 1.5 wt %, about 0.001 wt % to about 1.2 wt %, about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 3 wt %, about 0.005 wt % to about 2.8 wt %, about 0.005 wt % to about 2.5 wt %, about 0.005 wt % to about 2.2 wt %, about 0.005 wt % to about 2 wt %, about 0.005 wt % to about 1.8 wt %, about 0.005 wt % to about 1.5 wt %, about 0.005 wt % to about 1.2 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 3 wt %, about 0.01 wt % to about 2.8 wt %, about 0.01 wt % to about 2.5 wt %, about 0.01 wt % to about 2.2 wt %, about 0.01 wt % to about 2 wt %, about 0.01 wt % to about 1.8 wt %, about 0.01 wt % to about 1.5 wt %, about 0.01 wt % to about 1.2 wt %, about 0.01 wt % to about 1 wt %, about 0.01 wt % to about 0.9 wt %, about 0.01 wt % to about 0.8 wt %, about 0.01 wt % to about 0.5 wt %, about 0.05 wt % to about 3 wt %, about 0.05 wt % to about 2.8 wt %, about 0.05 wt % to about 2.5 wt %, about 0.05 wt % to about 2.2 wt %, about 0.05 wt % to about 2 wt %, about 0.05 wt % to about 1.8 wt %, about 0.05 wt % to about 1.5 wt %, about 0.05 wt % to about 1.2 wt %, about 0.05 wt % to about 1 wt %, about 0.05 wt % to about 0.9 wt %, about 0.05 wt % to about 0.8 wt %, about 0.05 wt % to about 0.5 wt %, about 0.05 wt % to about 0.1 wt %, about 0.1 wt % to about 3 wt %, about 0.1 wt % to about 2.8 wt %, about 0.1 wt % to about 2.5 wt %, about 0.1 wt % to about 2.2 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.6 wt %, about 0.1 wt % to about 0.5 wt %, about 0.1 wt % to about 0.2 wt %, about 0.2 wt % to about 3 wt %, about 0.2 wt % to about 2.8 wt %, about 0.2 wt % to about 2.5 wt %, about 0.2 wt % to about 2.2 wt %, about 0.2 wt % to about 2 wt %, about 0.2 wt % to about 1.8 wt %, about 0.2 wt % to about 1.5 wt %, about 0.2 wt % to about 1.2 wt %, about 0.2 wt % to about 1 wt %, about 0.2 wt % to about 0.8 wt %, about 0.2 wt % to about 0.6 wt %, about 0.2 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, or about 3 wt % of the total weight of the powder composition.

In some preferred embodiments, the powder composition comprises pigment in an amount from about 0.05 wt % to about 1.5 wt % or about 0.1 wt % to about 1 wt %. It has been discovered that in the above preferred ranges, the colors can generally be successfully imparted to the powder while at the same time does not cause fabric stain across different choices of pigments.

The fragrance oil is any suitable scented oil generally regarded as safe (GRAS) at the levels used in the powder composition. The fragrance oil in the powder composition can be the same as or different from the fragrance in the encapsulated fragrance. In some aspects, the fragrance oil in the powder composition is the same as the fragrance in the encapsulated fragrance. In some aspects, the fragrance oil in the powder composition is different from the fragrance in the encapsulated fragrance.

Suitable fragrance oils can be natural or synthetic. Examples of natural oils include those extracted from a plant, flower, or fruit (e.g., basil oil, bay oil, bergamot oil, cinnamon oil, clove oil, lavender oil, eucalyptus oil, lavender oil, ginger oil, geranium oil, rose oil, blue tansy oil, tea tree oil, Moringa oil, lemon balm essential oil, lemongrass oil, thyme oil, rosemary oil, mint oil, lemon oil, orange oil, and grapefruit oil). In some aspects, the fragrance oil comprises a carrier oil, such as vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, sea buckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, Shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, Shea butter, butter, ghee, medium chain triglycerides (MCT), or any combination thereof.

In some aspects, the powder composition comprises from about 0.5 wt % to about 10 wt % of a fragrance oil relative to the total weight of the powder composition. For example, the fragrance oil can be present in an amount from about 0.5 wt % to about 8 wt %, about 0.5 wt % to about 5 wt %, 0.5 wt % to about 4 wt %, about 0.5 wt % to about 3 wt %, about 0.5 wt % to about 2 wt %, about 0.5 wt % to about 1.5 wt, about 0.5 wt % to about 1 wt %, about 0.5 wt % to about 0.8 wt %, about 1 wt % to about 10 wt %, about 1 wt % to about 8 wt %, about 1 wt % to about 5 wt %, about 1 wt % to about 4 wt %, about 1 wt % to about 3 wt %, about 1 wt % to about 2 wt %, about 1 wt % to about 1.8 wt %, about 1 wt % to about 1.5 wt %, about 1 wt % to about 1.2 wt %, about 1.5, wt % to about 10 wt %, about 1.5 wt % to about 8 wt %, about 1.5 wt % to about 5 wt %, about 1.5 wt % to about 4 wt %, about 1.5 wt % to about 3 wt %, about 1.5 wt % to about 2 wt %, about 1.5 wt % to about 1.8 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the powder composition.

The powder composition comprises a salt as an inert processing aid. The salt is any suitable salt, such as a chloride, a bromide, an iodide, a fluoride, a nitrate, a nitrite, a sulfate, a sulfite, a sulfide, a phosphate, a phosphide, a carbonate, a bicarbonate, or any combination thereof. The salt can be counterbalanced by any suitable counterion, such as a Group I (e.g., lithium, sodium, potassium), Group II (e.g., magnesium, calcium, barium), or ammonium cation. In some aspects, the counterion is a sodium cation, a potassium cation, or a combination of both. In some aspects, the powder composition comprises sodium chloride.

In some aspects, the powder composition comprises from about 80 wt % to about 98 wt % of the salt relative to the total weight of the powder composition. For example, the salt can be present in an amount from about 80 wt % to about 97 wt %, about 80 wt % to about 96 wt %, about 80 wt % to about 95 wt %, about 80 wt % to about 94 wt %, about 80 wt % to about 93 wt %, about 80 wt % to about 93 wt %, about 80 wt % to about 92 wt %, about 80 wt % to about 91 wt %, about 80 wt % to about 90 wt %, about 85 wt % to about 98 wt %, about 85 wt % to about 97 wt %, about 85 wt % to about 96 wt %, about 85 wt % to about 95 wt %, about 85 wt % to about 94 wt %, about 85 wt % to about 93 wt %, about 85 wt % to about 93 wt %, about 85 wt % to about 92 wt %, about 85 wt % to about 91 wt %, about 85 wt % to about 90 wt %, about 90 wt % to about 98 wt %, about 90 wt % to about 97 wt %, about 90 wt % to about 96 wt %, about 90 wt % to about 95 wt %, about 90 wt % to about 94 wt %, about 90 wt % to about 93 wt %, about 90 wt % to about 93 wt %, about 90 wt % to about 92 wt %, about 90 wt % to about 91 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, or about 98 wt % of the total weight of the powder composition.

The powder composition comprises a flow aid to keep the powder composition from caking or lumping. In an aspect, a suitable flow aid includes an inert solid that can absorb water. Examples of flow aids include, for example, silica, calcium oxide, a silicate (e.g., sodium silicate, sodium aluminosilicate, aluminium calcium silicate, calcium silicate, magnesium silicate,), an aluminate, a carbonate, a bicarbonate, a phosphate (e.g., sodium orthophosphate), a stearate (e.g., magnesium stearate), clay, flour, fly ash, starch, a zeolite, or a combination thereof. Flow aids in the form of salts can include one or more suitable counterions, such as a Group I. Group II, or ammonium cation. In an aspect, the powder composition comprises silica as a flow aid.

In some aspects, the powder composition comprises from about 0.05 wt % to about 10 wt % of a flow aid relative to the total weight of the powder composition. For example, the flow aid can be present in an amount from about 0.05 wt % to about 8 wt %, about 0.05 wt % to about 5 wt %, 0.05 wt % to about 4 wt %, about 0.05 wt % to about 3 wt %, about 0.05 wt % to about 2 wt %, about 0.05 wt % to about 1.5 wt %, about 0.05 wt % to about 1.2 wt %, about 0.05 wt % to about 1 wt %, about 0.05 wt % to about 0.8 wt %, about 0.1 wt % to about 10 wt %, about 0.1 wt % to about 8 wt %, about 0.1 wt % to about 5 wt %. 0.1 wt % to about 4 wt %, about 0.1 wt % to about 3 wt %, about 0.1 wt % to about 2 wt %, about 0.1 wt % to about 1.8 wt %, about 0.1 wt % to about 1.5 wt %, about 0.1 wt % to about 1.2 wt %, about 0.5 wt % to about 10 wt %, about 0.5 wt % to about 8 wt %, about 0.5 wt % to about 5 wt %, 0.5 wt % to about 4 wt %, about 0.5 wt % to about 3 wt %, about 0.5 wt % to about 2 wt %, about 0.5 wt % to about 1.5 wt, about 0.5 wt % to about 1 wt %, about 0.5 wt % to about 0.8 wt %, about 1 wt % to about 10 wt %, about 1 wt % to about 8 wt %, about 1 wt % to about 5 wt %, about 1 wt % to about 4 wt %, about 1 wt % to about 3 wt %, about 1 wt % to about 2 wt %, about 1 wt % to about 1.8 wt %, about 1 wt % to about 1.5 wt %, about 1 wt % to about 1.2 wt %, about 1.5, wt % to about 10 wt %, about 1.5 wt % to about 8 wt %, about 1.5 wt % to about 5 wt %, about 1.5 wt % to about 4 wt %, about 1.5 wt % to about 3 wt %, about 1.5 wt % to about 2 wt %, about 1.5 wt % to about 1.8 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the powder composition.

In an aspect, the unit dose product comprises
a water-soluble film material comprising a first compartment and a second compartment; wherein the first compartment is adjacent to the second compartment and the first and second compartments are separated by at least one layer of the film;
the first compartment encloses a liquid composition comprising an encapsulated fragrance, a non-aqueous solvent comprising polyethylene glycol, glycerin, and propylene glycol, a rheology modifier, a pH-adjusting agent, water, and a bitterant; and
the second compartment encloses a powder composition comprising a salt, a fragrance oil, a water-insoluble pigment, and a flow aid.

In an aspect, the unit dose product comprises
a water-soluble film material comprising a first compartment and a second compartment; wherein the first compartment is adjacent to the second compartment and the first and second compartments are separated by at least one layer of the film;
the first compartment encloses a liquid composition consisting essentially of an encapsulated fragrance, a non-aqueous solvent comprising polyethylene glycol, glycerin, and propylene glycol, a rheology modifier, a pH-adjusting agent, water, and a bitterant; and
the second compartment encloses a powder composition consisting essentially of a salt, a fragrance oil, a water-insoluble pigment, and a flow aid.

In an aspect, the unit dose product comprises
a water-soluble film material comprising a first compartment and a second compartment; wherein the first compartment is adjacent to the second compartment and the first and second compartments are separated by at least one layer of the film;
the first compartment encloses a liquid composition consisting of an encapsulated fragrance, a non-aqueous solvent comprising polyethylene glycol, glycerin, and propylene glycol, a rheology modifier, a pH-adjusting agent, water, and a bitterant; and
the second compartment encloses a powder composition consisting of a salt, a fragrance oil, a water-insoluble pigment, and a flow aid.

The unit dose product comprises at least two compartments, in which a first compartment is adjacent to a second compartment and the first and second compartments are separated by at least one layer of the film. The liquid and powder compositions are releasably disposed within the first and second compartments, respectively. In some aspects, the unit dose product comprises two compartments. In some aspects, the unit dose product can have more than 2 (e.g., 3 or 4) compartments that are sealed off from one another, and the liquid and powder compositions are releasably disposed within at least two of the compartments. In some aspects, the same powder composition is present in two compartments, while the liquid composition is disclosed in a third compartment that is adjacent to the compartments containing the powder compositions. In some aspects, different film compositions can be used to form different sections or compartments of the pouch. For example, different films can dissolve at different rates to provide timed release of the compartments' contents.

The sealing of a water-soluble film material (e.g., in the form of one or two sheets) to form a compartment can be performed using methods known to those of skill in the art. In some aspects, the water-soluble film material is sealed using heat-sealing, solvent scaling (e.g., water scaling), or ultraviolet (UV) scaling.

The first compartment is adjacent to the second compartment in any suitable configuration so long as the first and second compartments are separated by at least one layer of the water-soluble film. In an aspect, the second compartment surrounds (e.g., encircles) the first compartment. In an aspect, the first compartment surrounds (e.g., encircles) the second compartment. In another example, the first and second compartments share one side of the compartments.

The unit dose product (e.g., scent booster pack) can have any suitable shape and size, e.g., square, rectangular, oval, ellipsoid, super elliptical, or circular shape. In general, the size and shape of each compartment in the unit dose product is large enough to enclose (e.g., entrap) about 1 g to about 50 g total weight of each of the liquid and powder compositions. For example, each compartment can enclose about 1 g to about 45 g (e.g., about 1 g to about 40 g, about 1 g to about 35 g, about 1 g to about 30 g, about 1 g to about 25 g, about 1 g to about 20 g. or about 1 g to about 15 g). In some aspects, the first compartment comprising the liquid composition is smaller relative to the second compartment comprising the powder composition. In an aspect, the first compartment holds about 1 g to about 5 g of the liquid composition. In an aspect, the second compartment holds about 10 g to about 20 g of the powder composition.

The water-soluble film is desirably strong, flexible, shock resistant, and non-tacky during storage at both high and low temperatures and high and low humidities. Non-limiting examples of suitable materials for the water-soluble film include, e.g., polyvinyl alcohol (PVOH), polyvinyl acetate (PVA), film-forming cellulosic polymers, polyacrylic acid, polyacrylamide, polyanhydride, a polysaccharide, and combinations thereof. Examples of film-forming cellulosic polymer include, e.g., cellulose, cellulose ether, cellulose ester, cellulose amide, methylcellulose, carboxymethylcellulose sodium, ethylcellulose, hydroxyethyl cellulose, hydroxypropyl methyl cellulose (HPMC), and combinations thereof. Unit dose detergent packs, including water-soluble films, are described in U.S. Pat. Nos. 8,551,929, 10,774,294, and 11,492,574, the disclosures of which are incorporated herein by reference in their entirety. In some aspects, the water-soluble film material comprises polyvinyl alcohol, polyvinyl pyrrolidone, polyalkylene oxide, polyamide, polyacrylamide, polyacrylic acid, cellulose, a cellulose ether, a cellulose ester, a cellulose amide, polyvinyl acetate, polycarboxylic acid or a salt thereof, a peptide, a polysaccharide, a natural gum, or any combination thereof. In some aspects, the water-soluble film material comprises polyvinyl alcohol (PVOH) or polyvinyl acetate (PVA).

In an aspect, the water-soluble film material is polyvinyl alcohol (PVOH). In some aspects, the PVOH can have a number average molecular weight range of about 10,000 to about 100,000 g/mol (e.g., about 10,000 to about 80,000 g/mol, about 15,000 to about 60,000 g/mol, about 20,000 to about 50,000 g/mol, about 25,000 to about 40,000 g/mol, or about 27,000 to about 33,000).

In some aspects, the film material comprises a bitterant (e.g., denatonium benzoate) as described herein, to impart a bitter taste to help avoid accidental poisoning.

In some aspects, the film material can have a thickness of about 50 to about 100 μm (e.g., about 50 to about 90 μm, about 60 to about 100 μm, about 60 to about 90 μm, about 70 to about 100 μm, about 70 to about 90 μm, about 80 to about 100 μm, about 80 to about 90 μm, about 100 μm, about 99 μm, about 98 μm, about 97 μm, about 96 μm, about 95 μm, about 94 μm, about 93 μm, about 92 μm, about 91 μm, about 90 μm, about 89 μm, about 88 μm, about 87 μm, about 86 μm, about 85 μm, about 84 μm, about 83 μm, about 82 μm, about 81 μm, about 80 μm, about 79 μm, about 79 μm, about 78 μm, about 77 μm, about 76 μm, about 75 μm, about 74 μm, about 73 μm, about 72 μm, about 71 μm, about 70 μm, about 69 μm, about 68 μm, about 67 μm, about 66 μm, about 65 μm, about 64 μm, about 63 μm, about 62 μm, about 61 μm, about 60 μm, about 59 μm, about 58 μm, about 57 μm, about 56 μm, about 55 μm, about 54 μm, about 53 μm, about 52 μm, about 51 μm, or about 50 μm). In some aspects, the film material will have a thickness of about 80 to about 90 μm or about 88 μm.

In some aspects, the present disclosure is directed to a method of using the unit dose product of any of the foregoing aspects. In an aspect, the method is directed to imparting fragrance to a textile (e.g., fabric) comprising adding the unit dose product described herein to water to form a composition; and contacting the textile with the composition to form a washing load. Optional steps include mixing (e.g., agitating) the washing load, removing at least a portion of the composition to provide a clean textile, rinsing the clean textile with additional water, and isolating the textile with imparted fragrance.

It was discovered that the order of addition in manufacturing the powder composition influenced the powder color and ability to stain. As a result, the powder can be produced using different orders to provide different benefits.

It was discovered that the following order of addition maximizes brightness and color intensity of the powder: 1) salt base, 2) fragrance oil, 3) flow aid, and 4) pigment. While not wishing to be bound by theory, it is believed that the brightened appearance was due to the pigment coating the outside of each granule and not being covered by the flow aid. This is also believed to be why powder made using this order of addition is more prone to staining fabrics. When the powder contacts the fabric, the pigment is unhindered in depositing onto the fabric. To mitigate stain risk, it was discovered that pigments incorporated using this order of addition should be included at levels as low as 0.001-0.5 wt %.

It was discovered that the following alternative order of addition minimizes risk of staining fabrics: 1) salt base, 2) fragrance oil, 3) pigment, and 4) flow aid. While not wishing to be bound by theory, it is believed that when powder is produced using this order of addition, pigment first coats the granules of the salt base. Then flow aid coats the pigmented granules. The flow aid coating hinders staining but also dulls color. To maintain aesthetic acceptability, in some aspects, some pigments can be included at levels as high as about 1 wt % to about 3 wt % to overcome this color dulling.

Accordingly, the present disclosure is directed to a method of preparing the powder composition enclosed in the second compartment of a unit dose product described herein. The method comprises adding the pigment to the salt to provide a pigment-salt combination; followed by adding the flow aid to the pigment-salt combination. In some aspects, the method further comprises first providing a salt, followed by adding a fragrance oil to the salt, followed by adding the pigment to form the pigment-salt combination.

In another aspect, the present disclosure is directed to a method of preventing pigment stains on a textile comprising providing the unit dose product, in which the powder composition is prepared by adding the pigment to the salt followed by adding the flow aid, and contacting the unit dose product and the textile in the presence of water. In some aspects, the method further comprises first providing a salt, followed by adding a fragrance oil, followed by adding the pigment.

In some aspects, the method further comprises rinsing the textile with water and drying the textile. Once the textile has been dried, the presence or absence of a pigment stain can be visually measured. When a stain has been prevented, the visual measurement can be labeled as “clean” or “small amount of acceptable staining.” In some aspects of this method, the powder composition in the unit dose product comprises about 0.001 wt % to about 3 wt % (e.g., about 0.05 wt % to about 3 wt %, about 0.5 wt % to about 3 wt %, about 1 wt % to about 3 wt %) of pigment.

In some aspects, the textile is cotton, silk, wool, polyester, rayon, leather, linen, muslin, velvet, chenille, brocade, chiffon, denim, taffeta, organza, crepe, poplin, broadcloth, or any combination thereof. In some aspects, the textile is cotton.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

Unit dose products 1 through 4 comprising liquid and powder compositions were prepared in accordance with the components listed in Tables 1-4. The formulations were batched using a standard overhead mixer. The liquid composition had a target pH of about 5.5 to 7.

TABLE 1

| | Wt % in | Wt % in | Liquid | % | Wt % in |
|---|---|---|---|---|---|
| Raw Material | Liquid | Powder | Weight (g) | Liquid | Pac |
| Polyethylene glycol | 35 | | 1.5 | 8.63 | 3.02 |
| Glycerin | 24.96 | | | | 2.15 |
| Propylene glycol | 11.89 | | | | 1.03 |
| Encapsulated fragrance | 25 | | | | 2.16 |
| Hydrophobic-modified | 2.25 | | | | 0.19 |
| polyacrylic | | | | | |
| acid, HASE | | | | | |
| rheology modifier | | | | | |
| Triethanolamine | 0.85 | | | | 0.07 |
| Denatonium Benzoate, | 0.05 | | | | 0 |
| 25% w/v in PG | | | | | |
| | | | Powder | % | Wt % in |
| Raw Material | | | Weight (g) | Powder | Pac |
| Sodium Chloride | | 95.02 | 15.1 | 86.88 | 82.55 |
| Fragrance #1 | | 2.88 | | | 2.50 |
| Ultramarine Blue | | 0.10 | | | 0.09 |
| Synthetic | | 2.00 | | | 1.74 |
| amorphous silica | | | | | |
| | | | Film | | Wt % in |
| Raw Material | | | Weight (g) | % Film | Pac |
| Polyvinyl alcohol film | | | 0.78 | 4.49 | 4.49 |
| (88 μm) | | | | | |
| Total | 100.00 | 100.00 | | 100.00 | 100.00 |

PG: propylene glycol

TABLE 2

| | Wt % in | Wt % in | Liquid | % | Wt % in |
|---|---|---|---|---|---|
| Raw Material | Liquid | Powder | Weight (g) | Liquid | Pac |
| Polyethylene glycol | 35 | | 1.5 | 8.63 | 3.02 |
| Glycerin | 24.96 | | | | 2.15 |
| Propylene glycol | 11.89 | | | | 1.03 |
| Encapsulated fragrance | 25 | | | | 2.16 |
| Hydrophobic-modified | 2.25 | | | | 0.19 |
| polyacrylic | | | | | |
| acid, HASE | | | | | |
| rheology modifier | | | | | |
| Triethanolamine | 0.85 | | | | 0.07 |
| Denatonium Benzoate, | 0.05 | | | | 0 |
| 25% w/v in PG | | | | | |
| | | | Powder | % | Wt % in |
| Raw Material | | | Weight (g) | Powder | Pac |
| Sodium Chloride | | 95.08 | 15.1 | 86.88 | 82.6 |
| Fragrance #2 | | 2.91 | | | 2.53 |
| Carmine | | 0.01 | | | 0.01 |
| Synthetic | | 2.00 | | | 1.74 |
| amorphous silica | | | | | |
| | | | Film | | Wt % in |
| Raw Material | | | Weight (g) | % Film | Pac |
| Polyvinyl alcohol film | | | 0.78 | 4.49 | 4.49 |
| (88 μm) | | | | | |
| Total | 100.00 | 100.00 | | 100.00 | 100.00 |

PG: propylene glycol

TABLE 3

| | Wt % in | Wt % in | Liquid | % | Wt % in |
|---|---|---|---|---|---|
| Raw Material | Liquid | Powder | Weight (g) | Liquid | Pac |
| Polyethylene glycol | 35 | | 1.5 | 8.63 | 3.02 |
| Glycerin | 24.96 | | | | 2.15 |
| Propylene glycol | 11.89 | | | | 1.03 |
| Encapsulated fragrance | 25 | | | | 2.16 |
| Hydrophobic-modified | 2.25 | | | | 0.19 |
| polyacrylic | | | | | |
| acid, HASE | | | | | |
| rheology modifier | | | | | |
| Triethanolamine | 0.85 | | | | 0.07 |
| Denatonium Benzoate, | 0.05 | | | | 0 |
| 25% w/v in PG | | | | | |
| | | | Powder | % | Wt % in |
| Raw Material | | | Weight (g) | Powder | Pac |
| Sodium Chloride | | 95.55 | 15.1 | 86.88 | 83.2 |
| Fragrance #3 | | 2.44 | | | 2.12 |
| Carmine | | 0.01 | | | 0.01 |
| Synthetic | | 2.00 | | | 1.74 |
| amorphous silica | | | | | |
| | | | Film | | Wt % in |
| Raw Material | | | Weight (g) | % Film | Pac |
| Polyvinyl alcohol film | | | 0.78 | 4.49 | 4.49 |
| (88 μm) | | | | | |
| Total | 100.00 | 100.00 | | 100.00 | 100.00 |

PG: propylene glycol

TABLE 4

| | Wt % in | Wt % in | Liquid | % | Wt % in |
|---|---|---|---|---|---|
| Raw Material | Liquid | Powder | Weight (g) | Liquid | Pac |
| Polyethylene glycol | 35 | | 1.5 | 8.63 | 3.02 |
| Glycerin | 24.96 | | | | 2.15 |
| Propylene glycol | 11.89 | | | | 1.03 |
| Encapsulated fragrance | 25 | | | | 2.16 |
| Hydrophobic-modified | 2.25 | | | | 0.19 |
| polyacrylic | | | | | |
| acid, HASE | | | | | |
| rheology modifier | | | | | |
| Triethanolamine | 0.85 | | | | 0.07 |
| Denatonium Benzoate, | 0.05 | | | | 0 |
| 25% w/v in PG | | | | | |
| | | | Powder | % | Wt % in |
| Raw Material | | | Weight (g) | Powder | Pac |
| Sodium Chloride | | 95.75 | 15.1 | 86.88 | 83.19 |
| Fragrance #4 | | 2.15 | | | 1.87 |
| Ultramarine Blue | | 0.1 | | | 0.09 |
| Synthetic | | 2.00 | | | 1.74 |
| amorphous silica | | | | | |
| | | | Film | | Wt % in |
| Raw Material | | | Weight (g) | % Film | Pac |
| Polyvinyl alcohol film | | | 0.78 | 4.49 | 4.49 |
| (88 μm) | | | | | |
| Total | 100.00 | 100.00 | | 100.00 | 100.00 |

PG: propylene glycol

It was discovered that the order of addition in manufacturing the powder composition influenced the powder color and ability to stain. In particular, addition of pigment prior to the flow aid dulled the color and decreased the risk of staining fabric. The addition of the flow aid prior to the pigment brightened the color and increased the risk of staining fabric.

### Example 2

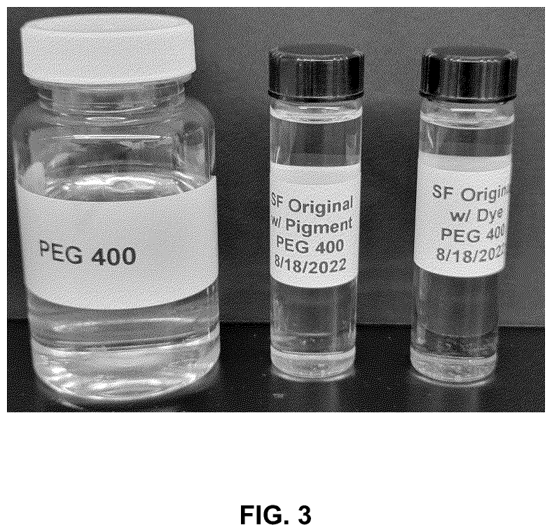

Spectrophotometer data showed a numerical split in color values for non-aqueous solvents that were soaked with dyed powder versus pigmented powders (FIG. 3). Both DE* and DEcmc, as measured in accordance with ASTM D2244-15e, represent the difference in color between a sample and its control (solvent alone), with higher values corresponding to greater color differences and indicating greater interaction between the solvent and colorant. The DE* and DEcmc values of compositions of solvents in combination with either a dye (Lt, aquamarine) or pigment (ultramarine) are set forth in Table 5. A DE* value less than 4 and a DEcmc value less than 6 correspond to solvent/colorant pairs that do not exhibit discoloration or spotting. DE* values greater 4 and DEcmc values greater than 6 correspond to solvent/colorant pairs that exhibit discoloration and/or spotting.

TABLE 5

| | | | | DE* vs | DEcmc vs |
|---|---|---|---|---|---|
| | L* | a* | b* | PEG400 | PEG400 |
| PEG 400 | 100.75 | 0.05 | −0.15 | N/A | N/A |
| (control) | | | | | |
| PEG 400, | 100.57 | −1.30 | 2.18 | 2.70 | 4.16 |
| pigment | | | | | |
| extraction | | | | | |
| PEG 400, dye | 98.24 | −7.16 | −1.65 | 7.77 | 11.38 |
| extraction | | | | | |
| | L* | a* | b* | DE* vs PG | DEcmc vs PG |
| PG (control) | 100.37 | −0.20 | 0.33 | N/A | N/A |
| PG, pigment | 99.80 | −1.95 | 3.69 | 3.83 | 5.72 |
| extraction | | | | | |
| PG, dye | 96.03 | −13.35 | −3.97 | 14.50 | 20.93 |
| extraction | | | | | |

Polyethylene glycol (e.g., PEG 400) and propylene glycol (PG) paired with dye had DE* values greater 4 and DEcmc values greater than 6, indicating a strong interaction between the solvents and the dye and that discoloration or spotting can be expected when used in a unit dose product. In comparison, polyethylene glycol (e.g., PEG 400) and PG paired with pigment had DE* less than 4 and DEcmc less than 6, indicating minimal interaction between the solvents and the pigment. Minimal interaction between the solvents and the colorant indicates that discoloration and spotting will be minimized in a unit dose product.

It had been assumed that dye instability was linked to water solubility. However, these data suggest dye instability could be linked to water, PEG 400, and/or PG solubility.

### Example 3

Powder compositions comprising a salt, a fragrance oil, a pigment, and a flow aid were prepared using various pigments in varying amounts. The powder was poured onto twelve fabric types, left to sit overnight, and rinsed. The degree of staining was visually measured. The results are set forth in Table 6.

TABLE 6

| | | Degree of |
|---|---|---|
| Pigment | Level | staining |
| Carmine | 0.05% | Small amount of |
| | | acceptable staining |
| C.I. Pigment Blue | 0.015% | Small amount of |
| | | acceptable staining |
| Diphosphoric | 0.02% | Clean |
| acid, ammonium | | |
| manganese(3+) salt (1:1:1) | | |
| Diphosphoric | 0.04% | Clean |
| acid, ammonium | | |
| manganese(3+) salt (1:1:1) | | |
| Diphosphoric | 0.06% | Clean |
| acid, ammonium | | |
| manganese(3+) salt (1:1:1) | | |
| C.I. Pigment Violet 15 | 0.03% | Clean |
| C.I. Pigment Violet 15 | 0.03% (amorphous | Small amount of |
| | silica added | acceptable staining |
| | before pigment) | |
| C.I. Pigment Violet 15 | 0.06% | Clean |
| C.I. Pigment Violet 15 | 0.5% | Noticeable |
| | | staining on |
| | | multiple fabrics |
| Ultramarine Blue | 1.0% | Clean |
| Ultramarine Blue | 1.5% | Noticeable |
| | | staining on Khaki |

C.I.: Color Index

Inventors of the present application and/or their colleagues have previously filed application Ser. Nos. 17/830,711, 17/564,980, and 17/941,582 in the field, the disclosures of these previously filed application are incorporated by references in their entireties.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A unit dose product comprising
a water-soluble film material comprising a first compartment and a second compartment; wherein the first compartment is adjacent to the second compartment and the first and second compartments are separated by at least one layer of the film;
the first compartment enclosing a liquid composition comprising an encapsulated fragrance and a non-aqueous solvent; and
the second compartment enclosing a powder composition comprising a salt, a fragrance oil, a pigment, and a flow aid.

2. The unit dose product of claim 1, wherein the liquid composition further comprises at least one additive selected from a rheology modifier, a pH-adjusting agent, water, and a bitterant.

3. The unit dose product of claim 1, wherein the pigment comprises at least one metal selected from the group consisting of aluminum, barium, cadmium, chromium, cobalt, copper, iron oxide, manganese, mercury, titanium, zinc, and any combination thereof.

4. The unit dose product of claim 1, wherein the powder composition comprises about 0.001 wt % to about 3 wt % of pigment.

5. The unit dose product of claim 1, wherein the powder composition does not contain a dye.

6. The unit dose product of claim 1, wherein the encapsulated fragrance comprises a polymer shell encapsulating at least one fragrance oil.

7. The unit dose product of claim 6, wherein the polymer shell comprises a polymer selected from the group consisting of a melamine formaldehyde, a polyamide, a polystyrene, a polyisoprene, a polycarbonate, a polyester, a polyurea, a polyurethane, a polyureaurethane, a polyolefin, a polyacrylate, a vinyl polymer, a polysaccharide, a gum, an epoxy resin, gelatin, shellac, silicone, silk, wool, gelatine, a cellulose, a protein, and any combination thereof.

8. The unit dose product of claim 1, wherein the non-aqueous solvent comprises an alcohol, a glycol, a polyethylene glycol, or any combination thereof.

9. The unit dose product of claim 8, wherein the non-aqueous solvent comprises polyethylene glycol, glycerin, and propylene glycol.

10. The unit dose product of claim 2, wherein the liquid composition comprises water in an amount of 1 wt % to 20 wt % relative to the components in the liquid composition.

11. The unit dose product of claim 10, wherein the liquid composition comprises about 10 wt % to about 20 wt % water.

12. The unit dose product of claim 2, wherein the liquid composition comprises a rheology modifier that is an acrylic polymer, an acrylic copolymer, an Alkali Soluble Emulsion (ASE) polymer, or a Hydrophobically Modified Alkali Soluble Emulsion (HASE) polymer.

13. The unit dose product of claim 12, wherein the rheology modifier is a copolymer comprising acrylic acid monomer units and alkyl acrylate monomer units.

14. The unit dose product of claim 2, wherein the liquid composition comprises a pH adjusting agent that is selected from the group consisting of triethanolamine, monoethanolamine, tromethamine, sodium carbonate, sodium bicarbonate, trisodium phosphate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), tetrasodium glutamate diacetate (GLDA), hydrochloric acid, nitric acid, nitrous acid, sulfuric acid, sulfurous acid, phosphoric acid, boric acid, hydrobromic acid, hydroiodic acid, perchloric acid, formic acid, acetic acid, propionic acid, butanoic acid, quinic acid, shikimic acid, lactic acid, sorbic acid, caproic acid, caprylic acid, capric acid, lauric acid, and stearic acid, citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, oxalic acid, and any combination thereof.

15. The unit dose product of claim 1, wherein the salt comprises a chloride, a bromide, a iodide, a fluoride, a nitrate, a nitrite, a sulfate, a sulfite, a sulfide, a phosphate, a phosphide, a carbonate, a bicarbonate, or any combination thereof.

16. The unit dose product of claim 1, wherein the flow aid comprises silica, calcium oxide, a silicate, an aluminate, a carbonate, a bicarbonate, a phosphate, a stearate, clay, flour, fly ash, starch, zeolite, or a combination thereof.

17. The unit dose product of claim 1, wherein the second compartment surrounds the first compartment.

18. The unit dose product of claim 1, wherein the water-soluble film material comprises polyvinyl alcohol.

19. A method of preparing the powder composition of the unit dose product of claim 1 comprising adding the pigment to the salt to provide a pigment-salt combination; followed by adding the flow aid to the pigment-salt combination.

20. The method of claim 19, wherein the powder composition comprises about 0.001 wt % to about 3 wt % of pigment.
